(19) United States
(12) Patent Application Publication
(10) Pub. No.: US 2026/0179825 A1
(43) Pub. Date: Jun. 25, 2026

(54) INTEGRATED VERTICAL INDUCTORS

(71) Applicant: Analog Devices, Inc., Wilmington, MA (US)

(72) Inventors: Deepak Kumar, Norwood, MA (US); Ruida Yun, Weston, MA (US); Baoxing Chen, Westford, MA (US)

(73) Assignee: Analog Devices, Inc., Wilmington, MA (US)

(21) Appl. No.: 19/418,415

(22) Filed: Dec. 12, 2025

Related U.S. Application Data
(60) Provisional application No. 63/736,037, filed on Dec. 19, 2024.

(51) Int. Cl. H01F 27/28; H01F 27/24; H01F 27/32; H01F 27/42

(52) U.S. Cl. CPC H01F 27/2804; H01F 27/24; H01F 27/324; H01F 27/42; H01F 2027/2819

(57) ABSTRACT

A method of manufacturing a vertical inductor, the method comprising: forming a substrate, forming a bottom electrode, forming a dielectric layer, forming a magnetic core, forming insulation layer, forming a conductive loop structure by extending vertical interconnects through the insulation layer from a first side of the magnetic core to a second side of the magnetic core, electrically connecting the vertical interconnects to the bottom electrode on the second side of the magnetic core.

### CROSS-REFERENCE TO RELATED APPLICATIONS

This application claims priority to U.S. Provisional Patent Application No. 63/736,037, filed December 19, 2024, which is incorporated by reference in its entirety.

### FIELD

The present disclosure generally relates to integrated vertical inductors.

### BACKGROUND

Inductors are components in many electronic circuits, particularly in power management applications such as voltage regulators and DC-DC converters. Traditionally, inductors have been implemented as discrete components or as planar structures integrated into printed circuit boards or semiconductor packages. These conventional approaches have allowed for the creation of inductors with varying levels of performance and integration, suitable for a wide range of applications in consumer electronics, telecommunications, and industrial systems.

### SUMMARY

This summary is provided to introduce a selection of concepts in a simplified form that are further described below in the detailed description. This summary is not intended to identify features of the claimed subject matter, nor is it intended to be used as an aid in determining the scope of the claimed subject matter.

In one aspect, the present disclosure relates to a method of manufacturing a vertical inductor, the method comprising forming a substrate, forming a bottom electrode, forming a dielectric layer, forming a magnetic core, forming insulation layer, and forming a conductive loop structure by extending vertical interconnects through the insulation layer from a first side of the magnetic core to a second side of the magnetic core, and electrically connecting the vertical interconnects to the bottom electrode on the second side of the magnetic core.

In one aspect, the present disclosure relates to a vertical inductor comprising a magnetic core disposed on a substrate, wherein the magnetic core comprising insulated vias extending through a cross section of the magnetic core, and a conductive loop structure comprising vertical interconnects extending through the insulated vias from a first side of the magnetic core to a second side of the magnetic core, the vertical interconnects electrically connected to each other on the second side of the magnetic core by a horizontal conductive layer, the vertical interconnects comprising separate electrical connections on the first side of the magnetic core.

In one aspect, the present disclosure relates to a system comprising an electronic device, and a vertical inductor coupled to the electronic device, the vertical inductor comprising a magnetic core disposed on a substrate, the magnetic core comprising insulated vias extending through a cross section of the magnetic core, and a conductive loop structure comprising vertical interconnects extending through the insulated vias from a first side of the magnetic core to a second side of the magnetic core, the vertical interconnects electrically connected to each other on the second side of the magnetic core by a horizontal conductive layer, the vertical interconnects comprising separate electrical connections on the first side of the magnetic core, the electronic device coupled to the separate electrical connections.

### BRIEF DESCRIPTION OF THE DRAWINGS

So that the way the above-recited features of the present disclosure can be understood in detail, a more particular description of the disclosure, briefly summarized above, may be made by reference to example embodiments, some of which are illustrated in the appended drawings. It is to be noted, however, that the appended drawings illustrate only example embodiments of this disclosure and are therefore not to be considered limiting of its scope, for the disclosure may admit to other equally effective example embodiments.

FIG. 1A illustrates a cross-sectional view of a vertical inductor device, according to aspects of the present disclosure.

FIG. 1B illustrates a cross-sectional view of a vertical inductor device with a U-shaped conductive path, according to aspects of the present disclosure.

FIG. 1C illustrates a cross-sectional view of a device with multiple vertical inductor structures, according to aspects of the present disclosure.

FIG. 1D illustrates a perspective view of a multi-phase vertical inductor, according to aspects of the present disclosure.

FIG. 2A illustrates a flowchart showing a method for designing a vertical inductor, according to aspects of the present disclosure.

FIG. 2B illustrates a flowchart of a method for fabricating a vertical inductor, according to aspects of the present disclosure.

FIG. 3A illustrates a cross-sectional view of a system showing vertical integration of inductor components, according to aspects of the present disclosure.

FIG. 3B illustrates a cross-sectional view of a system with vertical integration of components, according to aspects of the present disclosure.

FIG. 3C illustrates a cross-sectional view of a system with vertical integration of components, according to aspects of the present disclosure.

FIG. 4 illustrates a flowchart showing a method for installing a vertical inductor device, according to aspects of the present disclosure.

FIG. 5A illustrates a perspective view of a magnetic field simulation for a multi-phase vertical inductor structure, according to aspects of the present disclosure.

FIG. 5B illustrates performance characteristics and specifications of a vertical inductor design, according to aspects of the present disclosure.

FIG. 5C illustrates a perspective view of a magnetic field simulation for a multi-phase vertical inductor structure, according to aspects of the present disclosure.

FIG. 5D illustrates performance characteristics and parameters of a vertical inductor system, according to aspects of the present disclosure.

FIG. 5E illustrates three performance graphs showing electrical characteristics of a vertical inductor design, according to aspects of the present disclosure.

### DETAILED DESCRIPTION

As electronic devices continue to shrink in size while demanding higher performance and efficiency, traditional inductor designs face significant challenges. Planar inductors integrated into semiconductor chips often struggle to achieve sufficiently high inductance values and quality factors within the limited available area. Discrete inductors, while capable of higher performance, occupy valuable board space and introduce additional complexity in assembly and interconnection. Furthermore, the increasing operating frequencies of modern electronic systems exacerbate issues related to electromagnetic interference and power losses in conventional inductor designs. These limitations pose obstacles to the continued miniaturization and performance improvement of electronic devices, particularly in applications requiring high-power density and efficiency.

The present disclosure provides a vertical inductor solution for integration within semiconductor chips, particularly for power management applications. This novel design utilizes the vertical dimension of chip architecture to create efficient, space-saving inductors that may achieve high inductance and quality factor while remaining compatible with existing fabrication processes.

In contrast to traditional planar inductors, which occupy significant horizontal area on a chip, vertical inductors may be positioned either below or above the electronic device (e.g. central processing unit (CPU), graphics processing unit (GPU), voltage regulator, DC-DC converter, etc.) or sandwiched between multiple electronic devices. This vertical integration may allow for more efficient use of chip real estate, potentially enabling higher component density and improved overall system performance.

The basic structure of a vertical inductor may include a magnetic core, vertical interconnects, and electrode structures. The magnetic core may be formed from materials compatible with semiconductor processes, while the vertical interconnects may create conductive pathways through the core. Electrode structures at the top and bottom of the inductor may facilitate connections to other components within the chip or to external circuitry.

Vertical inductors may be designed as either integrated components within a larger chip architecture or as discrete components that can be separately manufactured and incorporated into a system. This flexibility in implementation may allow for optimized designs tailored to specific application requirements.

The applications for vertical inductors may be particularly suited to power management systems. In some cases, vertical inductors may be employed in integrated voltage regulators (IVRs), where their high inductance and quality factor may contribute to improved power conversion efficiency. Additionally, vertical inductors may find use in radio frequency (RF) systems and power amplifiers, where their compact size and high-frequency performance characteristics may be advantageous.

One of the benefits of vertical inductors may be their ability to operate effectively at high frequencies. The vertical architecture may allow for reduced parasitic capacitance and resistance compared to planar designs, potentially enabling improved performance in high-frequency applications. This characteristic may make vertical inductors particularly well-suited for modern electronic systems that demand efficient power management at increasingly higher operating frequencies.

The vertical inductor design offers several benefits and advantages that address challenges in modern electronic systems. One significant advantage may be the space efficiency achieved through vertical integration. By utilizing the vertical dimension of chip architecture, vertical inductors may allow for more compact designs compared to traditional planar inductors. This space-saving characteristic may enable higher component density and improved overall system performance in applications where board space is at a premium.

In addition to space efficiency, vertical inductors may offer improved performance characteristics. The vertical architecture may allow for reduced parasitic capacitance and resistance compared to planar designs, potentially enabling better performance in high-frequency applications. This may be particularly beneficial in power management systems, where efficient operation at high frequencies is increasingly beneficial.

Another advantage of vertical inductors may be their compatibility with existing semiconductor fabrication processes. By utilizing materials and techniques that are compatible with standard semiconductor manufacturing, vertical inductors may be more easily integrated into existing chip designs and production lines. This compatibility may reduce manufacturing complexity and costs associated with introducing new components into semiconductor devices.

The design of vertical inductors may allow for precise control over inductance values. In some cases, the cross section of the magnetic core may be dimensioned relative to the conductive loop structure to achieve a target inductance value. This ability to fine-tune inductance may provide designers with greater flexibility in meeting specific circuit requirements.

The dimensions of the magnetic core relative to the vertical interconnects and bottom electrode of the conductive loop may be carefully designed to achieve desired inductance values in vertical inductor structures. This dimensional relationship may play a role in determining the overall performance characteristics of the inductor.

In some aspects, the cross-sectional area of the magnetic core may be adjusted relative to the conductive loop structure to influence the inductance. A larger cross-sectional area of the magnetic core may increase the magnetic flux linkage, potentially resulting in higher inductance values. Conversely, a smaller cross-sectional area may lead to lower inductance values.

The spacing between the vertical interconnects may be another dimensional parameter that can be adjusted to influence inductance. In some implementations, closer spacing between the vertical interconnects may result in stronger magnetic coupling, potentially leading to higher inductance values. However, the spacing may be balanced with other factors such as current handling capacity and electromagnetic interference considerations.

The thickness of the bottom electrode may also play a role in determining the inductance. In some cases, a thicker bottom electrode may provide lower resistance, which may improve the quality factor of the inductor. However, the thickness may be optimized in conjunction with other dimensional parameters to achieve the desired inductance value.

The shape and dimensions of the vertical interconnects themselves may be tailored to affect inductance. In some implementations, wider vertical interconnects may provide lower resistance but may also impact the magnetic field distribution within the core. The height-to-width ratio of the vertical interconnects may be optimized to balance between inductance and resistance.

In multi-phase inductor designs, the relative positioning of multiple conductive loop structures within the magnetic core may be adjusted to achieve desired coupling between phases. The spacing and alignment of these structures may influence the mutual inductance between phases, which may be a consideration in multi-phase power management applications.

The overall volume of the magnetic core relative to the conductive loop structure may be another parameter that designers may adjust. In some cases, a larger core volume relative to the conductive loop may allow for higher saturation current levels, which may be beneficial in high-power applications.

Advanced simulation tools and analytical models may be employed to optimize these dimensional relationships. Finite element analysis may be used to simulate the electromagnetic behavior of different dimensional configurations, allowing designers to iteratively refine the structure to achieve target inductance values.

In some implementations, the dimensions may be dynamically adjusted during the manufacturing process based on measured electrical characteristics. This adaptive approach may allow for fine-tuning of inductance values to meet specific application requirements.

Vertical inductors may also benefit from advanced magnetic core properties. In some implementations, the magnetic core may have perpendicular anisotropy with an easy axis perpendicular to a plane of the magnetic core. This magnetic orientation may contribute to improved inductor performance, particularly in high-frequency applications.

The physical dimensions of vertical inductors may be tailored to suit various applications. In some cases, the conductive loop and the magnetic core may have a thickness ranging from 8 micrometers to 100 micrometers. This range of thicknesses may allow for optimization of inductor performance while maintaining compatibility with different chip architectures and manufacturing processes.

These benefits and advantages may position vertical inductors as a promising solution for addressing the increasing demands of modern electronic systems, particularly in areas such as power management, RF systems, and high-frequency applications where efficient, compact, and high-performance inductors are beneficial.

In some aspects, the conductive loop structure of the vertical inductor may be configured in a “U-shaped” pattern, rather than having overlapping or intertwined coils as seen in traditional wound and planar inductor designs. This U-shaped configuration may allow the conductive loop to extend vertically through the magnetic core without intersecting or overlapping itself. The vertical interconnects may form the two upright portions of the "U", while the bottom electrode may complete the loop by connecting the lower ends of these vertical segments.

This non-overlapping, U-shaped design may offer several performance advantages over traditional inductors with overlapping coils. The absence of overlapping segments may reduce parasitic capacitance between different parts of the conductive loop, potentially leading to improved high-frequency performance. Additionally, the U-shaped configuration may allow for more uniform current distribution throughout the conductive loop, which may result in lower resistance and improved quality factor. The vertical orientation of the main conductive segments may also enable stronger magnetic coupling with the surrounding core material, potentially increasing the inductance density of the device. These factors may contribute to the overall efficiency and performance of the vertical inductor in various applications, particularly in high-frequency and power management scenarios. Of course, other non-overlapping shapes for the conductive loop are possible.

Vertical inductors may find applications in a wide range of electronic systems, particularly in areas where efficient power management and high-frequency operation are beneficial. In some cases, vertical inductors may be integrated into power management systems, where their compact size and high performance characteristics can contribute to improved overall system efficiency.

One potential application for vertical inductors may be in voltage regulators. Voltage regulators may require high-quality inductors to maintain stable output voltages, and vertical inductors may offer the desired performance in a compact form factor. In some cases, the vertical inductor may be coupled directly to the voltage regulator, allowing for efficient power delivery in a space-constrained environment.

DC-DC converters may also benefit from the integration of vertical inductors. These converters often operate at high frequencies and require inductors with low losses and high quality factors. Vertical inductors may meet these requirements while occupying less space than traditional planar inductors, potentially enabling more compact and efficient DC-DC converter designs.

In some cases, vertical inductors may be incorporated into processor designs. Modern processors may require sophisticated power delivery networks to manage their high power demands and fast transient responses. Vertical inductors may be integrated directly into the processor package or nearby interposer, potentially improving power delivery efficiency and reducing overall system size.

GPUs may represent another potential application for vertical inductors. GPUs often have high power requirements and may benefit from localized power delivery solutions. In some cases, vertical inductors may be integrated into GPU packages or nearby substrates, potentially enabling more efficient power delivery and improved thermal management.

Vertical inductors may also find applications in RF circuits, where their high-frequency performance characteristics may be particularly advantageous. In some cases, vertical inductors may be used in RF power amplifiers, filters, or matching networks, potentially enabling more compact and efficient RF system designs.

The compact nature of vertical inductors may make them suitable for use in portable electronic devices, where space is at a premium. In some cases, vertical inductors may be integrated into smartphone or tablet designs, potentially allowing for more efficient power management in a constrained form factor.

Automotive electronics may represent another potential application area for vertical inductors. As vehicles incorporate more advanced electronic systems, efficient power management becomes increasingly beneficial. Vertical inductors may be used in automotive power converters, motor drivers, or battery management systems, potentially contributing to improved overall vehicle efficiency.

In the field of Internet of Things (IoT) devices, vertical inductors may offer benefits in terms of miniaturization and power efficiency. IoT devices often require compact, low-power designs, and vertical inductors may help meet these requirements in applications such as sensor nodes or wearable devices.

The following paragraphs will provide a detailed description of the vertical inductor structures and their implementation, as illustrated in the accompanying figures. These figures may offer visual representations of various aspects of the vertical inductor design, including cross-sectional views, perspective illustrations, and schematic diagrams. The figures may depict the arrangement of components such as the substrate, magnetic core, conductive loop structures, and electrode configurations. Additionally, the figures may showcase different variations of the vertical inductor design, including single-phase and multi-phase configurations. Through these visual aids, the intricate details of the vertical inductor's construction, operation, and integration into larger electronic systems may be more clearly understood.

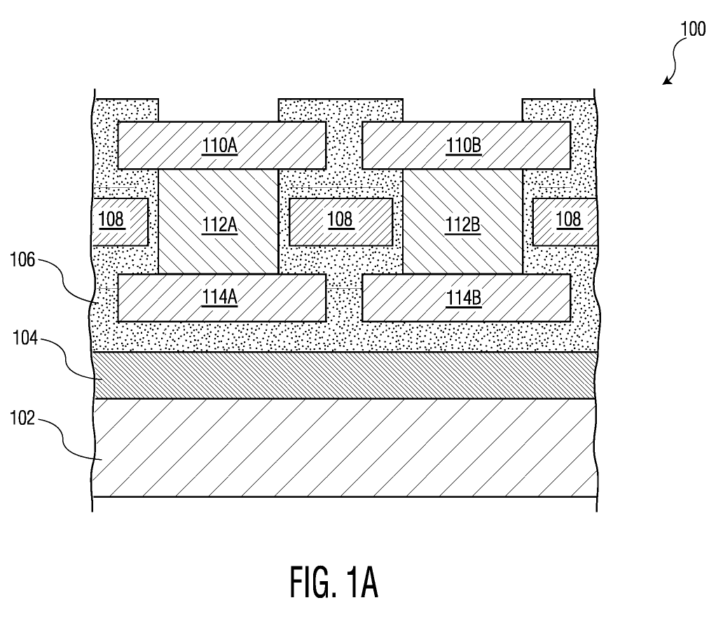

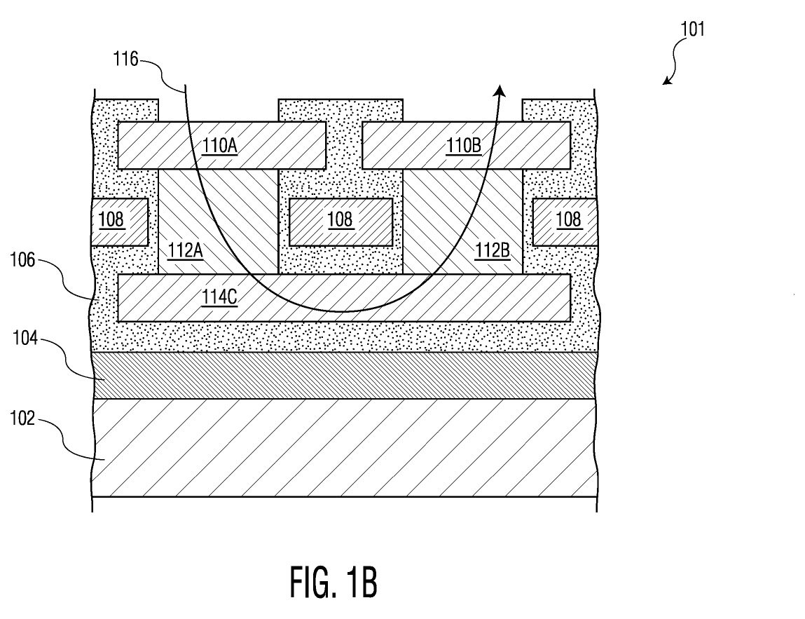

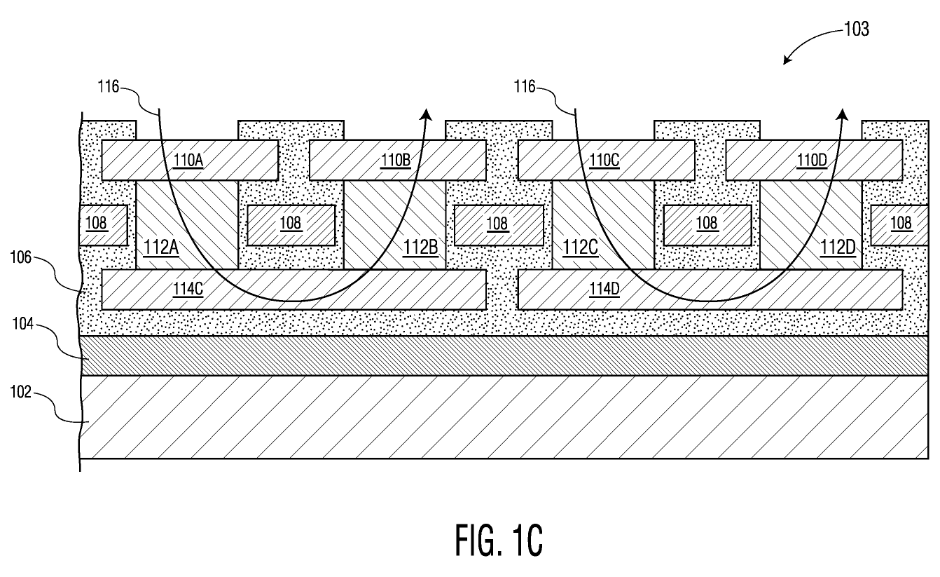

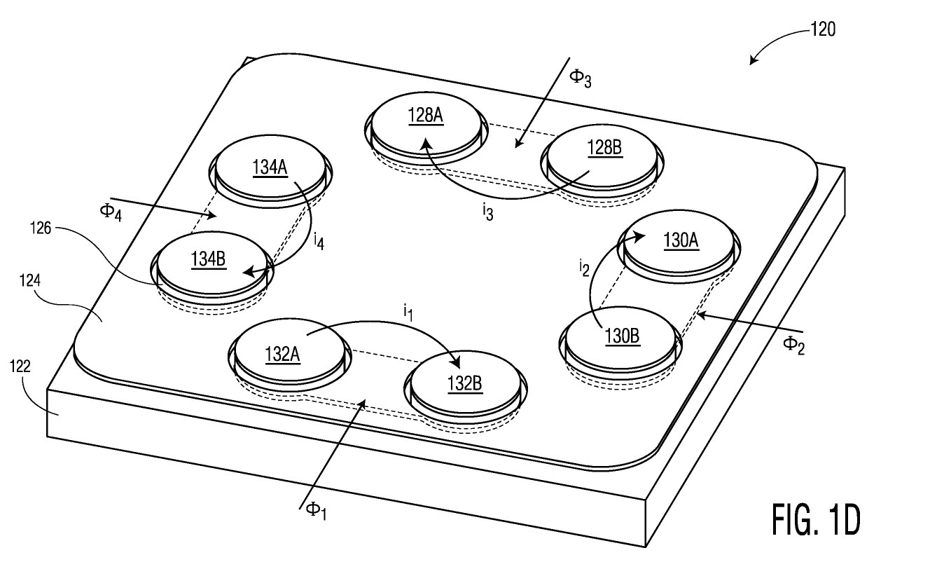

FIG. 1A illustrates a vertical inductor device 100 including a substrate 102, a dielectric layer 104, an insulation layer 106, magnetic core segments 108, top electrodes 110A and 110B, vertical interconnects 112A and 112B, and bottom electrodes 114A and 114B.

The device 100 may be built upon a substrate 102, which may serve as the foundation for the vertical inductor structure. A dielectric layer 104 may be positioned directly above the substrate 102, providing electrical insulation and a base for subsequent layers.

An insulation layer 106 may be formed above the dielectric layer 104. The insulation layer 106 may serve to electrically isolate various components of the device 100 from each other. Within the insulation layer 106, a magnetic core 108 may be embedded. The magnetic core 108 may be formed in a planar shape and may play a role in the inductive properties of the device 100. It is noted that the insulation layer 106 may comprise multiple dielectric layers that serve various isolation purposes throughout the vertical inductor structure, although not explicitly shown in the figure. These layers may extend between the conductive elements and the magnetic core, as well as above the core, providing necessary electrical isolation. In this context, the distinction between the dielectric layer 104 and the insulation layer 106 may be primarily functional rather than material-based, as both may utilize dielectric materials. The insulation layer 106 may specifically facilitate the fabrication and isolation of the conductor layers, interconnects, and magnetic core layers. It is important to note that the layer configuration shown in FIG. 1A represents just one possible arrangement, and the actual number, thickness, and composition of these layers may vary depending on the specific design requirements, manufacturing processes, and performance goals of the vertical inductor device.

The device 100 may include multiple vertical interconnects, such as vertical interconnect 112A and vertical interconnect 112B. These vertical interconnects may extend vertically through the insulation layer 106 and the magnetic core 108. The vertical interconnects 112A and 112B may be positioned on either side of the magnetic core 108, creating a conductive loop structure when connected to each other (not shown) via bottom electrodes.

At the upper portion of the device 100, top electrodes 110A and 110B may be positioned. These top electrodes may provide electrical connections to other components or layers above the vertical inductor. Similarly, at the lower portion of the device 100, bottom electrodes 114A and 114B may be located. The bottom electrodes may facilitate electrical connections to each other forming a single bottom electrode for completing the conductive loop.

The vertical interconnects 112A and 112B may electrically connect the top electrodes 110A and 110B to the bottom electrodes 114A and 114B, respectively. This arrangement may create conductive pathways through the device 100, forming the conductive loop structure of the vertical inductor.

In some cases, the magnetic core 108 may be formed using materials compatible with semiconductor processes, while the vertical interconnects 112A and 112B may be created using conductive materials such as copper or aluminum. The insulation layer 106 may be formed using dielectric materials to provide proper electrical isolation.

The combination of these components - the substrate 102, dielectric layer 104, insulation layer 106, magnetic core 108, vertical interconnects 112A and 112B, top electrodes 110A and 110B, and bottom electrodes 114A and 114B - may work together to form the vertical inductor structure. The magnetic core 108 may provide the inductive properties, while the conductive loop structure formed by the vertical interconnects and electrodes may allow for the flow of electrical current through the device 100.

This vertical architecture may allow for efficient use of space within a semiconductor chip, potentially enabling higher component density and improved overall system performance. The planar shape of the magnetic core 108 and the vertical orientation of the conductive loop structure may contribute to the compact nature of the device 100 while still achieving desired inductance values.

FIG. 1B illustrates a cross-sectional view of a vertical inductor device 101, which may include a substrate 102, a dielectric layer 104, an insulation layer 106, magnetic core segments 108, top electrodes 110A and 110B, vertical interconnects 112A and 112B, a bottom electrode 114C, and an electrical current path 116.

FIG. 1B is similar to FIG. 1A, but with the bottom electrodes 114A and 114B connected to form the bottom electrode 114C that completes the conductive loop such that an electrical current path 116 may flow from the top electrode 110A, through the vertical interconnect 112A, along the bottom electrode 114C, up through the vertical interconnect 112B, and to the top electrode 110B, forming a U-shaped conductive path around the magnetic core 108.

The U-shaped conductive path configuration in device 101 may optimize the use of space within the semiconductor chip while also aligning with modern needs for high-density and high-efficiency electronic components. This design approach may be particularly advantageous in power management systems, where efficient energy handling and minimal power loss may be beneficial. The vertical interconnects 112A and 112B may carry anti-parallel currents, which may minimize far-field emissions and electromagnetic interference (EMI). This configuration may result in the magnetic fields generated by the currents in each vertical interconnect partially cancelling each other out in the far-field region. As a result, the overall electromagnetic emissions from the device may be reduced, potentially improving its electromagnetic compatibility with other nearby electronic components or systems. In some cases, this reduction in EMI may be particularly beneficial in densely packed electronic assemblies or in applications where electromagnetic noise sensitivity is a concern, such as in high-precision measurement equipment or wireless communication devices. Additionally, the minimized far-field emissions may help the device comply with electromagnetic compatibility regulations more easily, potentially reducing the need for additional shielding or filtering components in the final product.

The U-shaped configuration may allow the conductive loop to extend vertically through the magnetic core without intersecting or overlapping itself. The vertical interconnects may form the two upright portions of the "U", while the bottom electrode may complete the loop by connecting the lower ends of these vertical segments. This non-overlapping design may offer several performance advantages over traditional inductors with overlapping coils.

In some cases, the absence of overlapping segments may reduce parasitic capacitance between different parts of the conductive loop, potentially leading to improved high-frequency performance. Additionally, the U-shaped configuration may allow for more uniform current distribution throughout the conductive loop, which may result in lower resistance and improved quality factor. The vertical orientation of the main conductive segments may also enable stronger magnetic coupling with the surrounding core material, potentially increasing the inductance density of the device.

These factors may contribute to the overall efficiency and performance of the vertical inductor in various applications, particularly in high-frequency and power management scenarios. The U-shaped design may allow for efficient utilization of the vertical dimension in chip architecture, potentially enabling higher component density and improved overall system performance in applications where board space is at a premium.

FIG. 1C illustrates a cross-sectional view of a device 103 showing a vertical inductor structure with multiple conductive loop structures, where the device 103 includes a substrate 102, a dielectric layer 104, an insulation layer 106, magnetic core segments 108, top electrodes 110A, 110B, 110C, and 110D, vertical interconnects 112A, 112B, 112C, and 112D, bottom electrodes 114C and 114D, and electrical current paths 116 and 118.

The device 103 may be built on the substrate 102 and may include multiple layers and components arranged in a vertical configuration. These multiple conductive loop structures may be arranged to interact and form a plurality of coupled inductors to achieve higher inductance values or to enable multi-phase operation. The coupling between adjacent inductor structures may potentially improve performance in applications such as multi-phase power conversion or voltage regulation.

The device 103 in FIG. 1C illustrates two vertical inductors integrated within the same structure. The first inductor may be identical to the one shown in FIG. 1B, including top electrodes 110A and 110B, vertical interconnects 112A and 112B, and bottom electrode 114C, forming a U-shaped conductive path around a portion of the magnetic core 108. The second inductor may include components such as top electrodes 110C and 110D, vertical interconnects 112C and 112D, and bottom electrode 114D, creating another U-shaped conductive path around a different portion of the magnetic core The electrical current paths 116 and 118 may be indicated by curved arrows showing the current flow through the electrode structures. It is noted that the coupled inductors may be arranged in a way that the in-plane flux from one inductor may cancel the in-plane flux from another inductor to potentially reduce core saturation as well as minimize electromagnetic interference (EMI). This arrangement may differ from the configuration shown in FIG. 1C, and instead may be implemented as seen in FIG. 1D (described below), where inductor 1 may be coupled with inductor 3, or inductor 2 may be coupled with inductor 4. In this configuration, a single coupled inductor pair may be formed by pairing inductors that are diagonally opposite each other, such as inductor 1 with inductor 3 or inductor 2 with inductor 4. This arrangement may allow for more effective flux cancellation between the coupled inductors, potentially leading to improved performance characteristics. The strategic positioning of the coupled inductors in this manner may contribute to enhanced efficiency and reduced electromagnetic emissions in multi-phase inductor designs.

In some cases, the vertical arrangement of these components creates two inductor structures within the device 103, with the magnetic core 108 positioned between the vertical interconnects to enhance the inductive properties of the device. This configuration may allow for creating multiple conductive loop structures on the magnetic core 108. The multiple conductive loop structures may be arranged to interact and form a plurality of coupled inductors. In some cases, this arrangement may be used for multi-phase applications or to achieve higher inductance values. The magnetic coupling between the adjacent inductor structures may allow for improved performance in multi-phase power conversion applications.

The coupled inductors may work together through mutual inductance, where the magnetic field generated by one inductor influences the others. This interaction may enhance the overall inductance and potentially improve power handling capabilities. In some implementations, the phase relationship between the coupled inductors may be controlled to optimize ripple cancellation and transient response in multi-phase voltage regulators. The vertical integration of these coupled inductors may allow for compact designs with reduced parasitic effects, potentially leading to higher efficiency and better thermal management in power conversion systems.

FIG. 1D illustrates a perspective view of a multi-phase vertical inductor 120, which may include a substrate 122, a magnetic core 124, insulated vias 126, and top electrodes 128A, 128B, 130A, 130B, 132A, 132B, 134A, and 134B arranged in pairs on the magnetic core 124.

The multi-phase vertical inductor 120 may be constructed on a substrate 122 and may include a magnetic core 124 positioned above the substrate 122. The structure may include multiple pairs of top electrodes arranged in a pattern across the magnetic core 124.

The top electrodes may be arranged in pairs: a top electrode 128A and a top electrode 128B (inductor 3), a top electrode 130A and a top electrode 130B (inductor 2), a top electrode 132A and a top electrode 132B (inductor 1), and a top electrode 134A and a top electrode 134B (inductor 4). Each electrode pair may be vertically connected through insulated via 126 structures that may pass through the magnetic core 124 and connect to respective bottom electrodes (not shown).

The magnetic core 124 may span across the substrate 122 and may provide a shared magnetic pathway for the multiple inductor phases. The arrangement may show four distinct phases, with each phase including a pair of top electrodes. In some implementations, the multi-phase vertical inductor 120 may be designed with four inductors arranged in a configuration where the magnetic flux from inductor 1 may cancel the flux from inductor 3, and the flux from inductor 2 may cancel the flux from inductor 4. This arrangement may potentially reduce core saturation and minimize electromagnetic interference (EMI). By strategically positioning the inductors in this manner, the opposing fluxes may effectively neutralize each other, which may lead to improved overall performance of the device. The flux cancellation may help maintain the magnetic core 124 within its linear operating region, potentially enhancing the inductor's efficiency and power handling capabilities. Additionally, this configuration may contribute to reduced electromagnetic emissions, which may be beneficial in densely packed electronic systems or applications sensitive to electromagnetic noise. The combination of reduced core saturation and minimized EMI may allow for higher current handling capabilities and improved signal integrity in high-frequency operations.

It is noted that the insulation layer above the magnetic core 124 is not explicitly shown in FIG. 1D for the sake of simplicity and clarity in illustrating the components of the multi-phase vertical inductor 120. It is understood that in practical implementations, an insulation layer may be present above the magnetic core 124 to provide electrical isolation between the magnetic core and the top electrodes, as well as to protect the underlying structures. This insulation layer may be similar in function to the insulation layer 106 described in previous figures, serving to electrically isolate various components of the device from each other.

In some cases, the design may incorporate copper conductors for the electrodes and vias, with the magnetic core 124 providing magnetic coupling between the phases. The vertical architecture may allow for efficient use of space while maintaining electromagnetic functionality. The arrangement of the electrode pairs may enable multi-phase operation with magnetic coupling through the shared magnetic core 124.

The multi-phase vertical inductor 120 may offer several benefits for high-power applications and improved efficiency. In some cases, the shared magnetic core 124 may allow for better magnetic coupling between phases, potentially reducing overall core losses. The multi-phase design may enable better current handling capabilities, which may be particularly advantageous in high-power applications such as voltage regulators for processors or GPUs.

In some cases, the magnetic core 124 may have in-plane anisotropy, where the magnetic properties are directionally dependent within the plane of the core. Alternatively, the magnetic core 124 may be isotropic, exhibiting uniform magnetic properties in all directions. The choice between in-plane anisotropy and isotropy may depend on the specific requirements of the application and may affect the overall performance of the multi-phase vertical inductor 120. In some cases, the magnetic core 124 may have perpendicular anisotropy with an easy axis perpendicular to the plane, where the magnetic properties are isotropic in the plane with a hard axis in the plane. This configuration may help reduce magnetic switching losses in the core material. The perpendicular anisotropy may allow for more efficient magnetization reversal processes, potentially leading to lower energy dissipation during high-frequency operation. The in-plane isotropy may provide uniform magnetic properties across the horizontal dimensions of the core, which may contribute to more consistent performance across different inductor phases.

The magnetic core 124 may be designed with different shapes to optimize performance for specific applications. In some cases, the magnetic core 124 may have a rectangular shape as shown in FIG. 1D. However, other shapes such as circular, oval, or custom polygonal shapes may be used depending on the design requirements and space constraints of the application.

The multi-phase design of the vertical inductor 120 may allow for improved ripple current cancellation, potentially resulting in smoother output voltage and reduced electromagnetic interference. This may be particularly beneficial in applications requiring high efficiency and low noise, such as sensitive analog circuits or high-performance digital systems.

The design process for vertical inductors such as those shown in FIGS. 1B-1D, may involve a systematic approach to ensure performance and manufacturability.

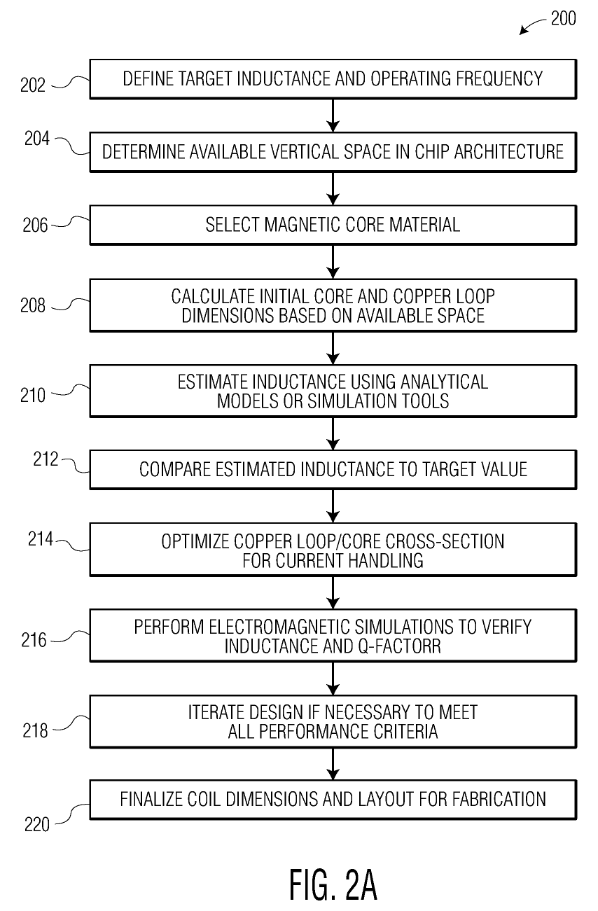

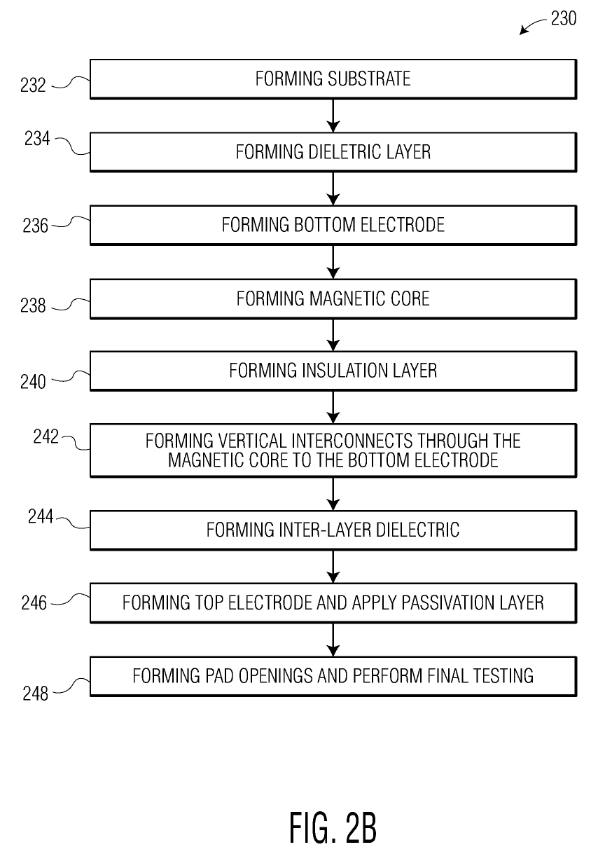

FIG. 2A illustrates a method 200 for designing a vertical inductor. The method 200 for designing a vertical inductor includes steps 202 (defining target inductance and operating frequency), 204 (determining available vertical space), 206 (selecting magnetic core material), 208 (calculating initial core and copper loop dimensions), 210 (estimating inductance), 212 (comparing estimated inductance to target value), 214 (optimizing copper loop and core cross-section), 216 (performing electromagnetic simulations), 218 (iterating design if desired), and 220 (finalizing coil dimensions and layout for fabrication).

The method 200 may begin with a step 202, where target inductance and operating frequency may be defined. These specifications may serve as the foundation for the design process, guiding subsequent decisions and optimizations. In some cases, the target inductance may be determined based on the specific application requirements, such as power conversion efficiency or ripple current reduction in voltage regulators.

Following the definition of target specifications, a step 204 may involve determining the available vertical space in the chip architecture. This step may be beneficial in ensuring that the vertical inductor design aligns with the overall chip layout and space constraints. The available vertical space may influence the dimensions of the magnetic core and the conductive loop structure.

In a step 206, a magnetic core material may be selected. The choice of magnetic core material may significantly impact the inductor's performance characteristics. In some cases, materials compatible with semiconductor processes, such as certain ferrites or magnetic alloys, may be considered. The selection may be based on factors such as magnetic permeability, saturation flux density, and compatibility with fabrication processes.

A step 208 may involve calculating initial core and copper loop dimensions based on the available space. This step may utilize analytical models or design rules to estimate the dimensions for achieving the target inductance. The dimensions of the magnetic core and the conductive loop structure may be interdependent, and their relationship may be carefully considered to optimize performance.

In some cases, the initial dimensions calculated in step 208 may serve as a starting point for further refinement. The process may involve iterative adjustments to balance factors such as inductance, quality factor, and current handling capacity. Advanced simulation tools may be employed to model the electromagnetic behavior of different dimensional configurations, allowing designers to fine-tune the structure to meet specific performance requirements. This approach may enable the creation of vertical inductors that efficiently utilize the available space while achieving the desired electrical characteristics.

The method 200 may proceed to a step 210, where the inductance may be estimated using analytical models or simulation tools. This step may provide an initial assessment of whether the calculated dimensions are likely to meet the target inductance. In some cases, finite element analysis or other computational methods may be employed to obtain more accurate estimates of the inductor's performance.

A step 212 may involve comparing the estimated inductance to the target value. This comparison may determine whether further optimization is desired or if the initial design meets the specified requirements. If the estimated inductance deviates significantly from the target value, the process may iterate back to previous steps for adjustments.

In step 214, the copper loop and core cross-section may be optimized for current handling. This step may involve refining the dimensions and geometry of the conductive loop structure and the magnetic core to ensure adequate current capacity while maintaining the desired inductance. Factors such as copper thickness, loop width, and core cross-sectional area may be adjusted to achieve the balance between inductance and current handling capability.

In some cases, the optimization process may involve iterative simulations and analysis to evaluate different design configurations. Advanced electromagnetic modeling tools may be employed to predict the performance of various copper loop and core geometries under different operating conditions. The results of these simulations may guide further refinements to the design, potentially leading to improved current handling without compromising the inductor's electrical characteristics. Additionally, thermal considerations may be taken into account during this optimization step, as the current handling capability may be influenced by the device's ability to dissipate heat effectively.

A step 216 may include performing electromagnetic simulations to verify inductance and quality factor. These simulations may provide more detailed insights into the inductor's performance across the intended operating frequency range. In some cases, 3D electromagnetic field solvers may be used to accurately model the complex interactions between the conductive loop structure and the magnetic core.

In step 218 the design may be iterated if desired to meet all performance criteria. This step may involve revisiting and adjusting various aspects of the design based on the simulation results. Multiple iterations may be performed to fine-tune the inductor's characteristics and ensure that all specifications are met.

Step 220 may involve finalizing the coil dimensions and layout for fabrication. This step may include preparing detailed design files and specifications for the manufacturing process. The final design may consider factors such as manufacturability, yield, and integration with other chip components.

The method 200 for designing vertical inductors may provide a structured approach to developing high-performance components for integrated circuits. By following this process, designers may optimize the vertical inductor's characteristics while ensuring compatibility with semiconductor manufacturing processes. The iterative nature of the method may allow for continuous refinement, potentially resulting in inductors that meet or exceed the target specifications while efficiently utilizing the available chip space.

It is noted that the steps illustrated in FIG. 2A are examples, and may be modified or adapted based on specific design requirements, available resources, or technological advancements. In some cases, certain steps may be reordered, combined, expanded, or even omitted.

FIG. 2B illustrates a method 230 for fabricating the designed vertical inductor. The method 230 for fabricating a vertical inductor includes steps 232 (forming a substrate), 234 (forming a dielectric layer), 236 (forming bottom electrode), 238 (forming a magnetic core), 240 (forming an insulation layer), 242 (forming vertical interconnects), 244 (forming an inter-layer dielectric), 246 (forming a top electrode and applying a passivation layer), and 248 (forming pad openings and performing final testing).

The method 230 may begin with a step 232, which may involve forming a substrate. In some cases, the substrate may be similar to the substrate 102 described in previous figures. Step 234 may involve forming a dielectric layer. This dielectric layer may be similar to the dielectric layer 104 described previously. Step 236 may include forming a bottom electrode on the substrate. This bottom electrode may be analogous to the bottom electrode 114C shown in earlier figures. Step 238 may include forming a magnetic core. The magnetic core formed in this step may be comparable to the magnetic core 108 discussed in earlier figures.

In step 240 an insulation layer may be formed. This insulation layer may be analogous to the insulation layer 106 described in previous figures. A step 242 may involve forming vertical interconnects through the magnetic core to connect to the bottom electrode. These vertical interconnects may be similar to the vertical interconnects 112A and 112B shown in earlier figures.

A step 244 may include forming an inter-layer dielectric. This step may be beneficial for providing electrical isolation between different conductive layers within the vertical inductor structure.

Step 246 may involve forming a top electrode and applying a passivation layer. The top electrode formed in this step may be analogous to the top electrodes 110A and 110B described in previous figures. The passivation layer may provide protection for the underlying structures.

Step 248 may include forming pad openings and performing final testing of the fabricated vertical inductor. This step may ensure that the vertical inductor meets the specifications and performance criteria.

In some cases, the manufacturing process may include additional specific steps. For example, after forming the bottom electrode, the process may involve depositing magnetic core material using techniques such as sputtering or electroplating. Patterning and etching steps may be employed to define the shape and dimensions of the magnetic core.

The formation of vertical interconnects may involve creating vias through the insulation layers to connect different levels of the inductor structure. Conductive coil formation may be achieved by depositing and patterning conductive layers, such as copper, to form the vertical coil structure around the magnetic core. This step may be repeated multiple times to create several inductors around the magnetic core.

Inter-layer dielectric deposition may occur between each conductive layer to provide proper insulation. The top electrode deposition may be followed by the application of a protective passivation layer over the structure. The pad opening step may create openings in the passivation layer for electrical connections. Final testing and characterization may involve performing electrical tests to verify the inductor's performance and characteristics. This fabrication process may allow for the vertical inductors to be manufactured alongside other chip components in a single, unified process, potentially enabling efficient integration of high-performance inductors into semiconductor devices.

In some implementations, steps in the fabrication process may be modified or omitted depending on the specific design requirements and manufacturing capabilities. For instance, the formation of a separate dielectric layer in step 234 may be combined with the substrate formation in step 232 if the substrate material provides sufficient dielectric properties. The formation of an inter-layer dielectric in step 244 may be unnecessary if the insulation layer formed in step 240 provides adequate electrical isolation between conductive layers. In some cases, the magnetic core formation in step 238 may be integrated with the insulation layer formation in step 240 if a composite material with both magnetic and insulating properties is used. The passivation layer application in step 246 may be optional if the top electrode material itself provides sufficient protection or if the inductor is to be immediately encapsulated in a subsequent packaging process. Additionally, the final testing step 248 may be modified or partially omitted if in-line testing during earlier fabrication stages provides sufficient quality assurance.

It is noted that the steps illustrated in FIG. 2B are examples, and may be modified or adapted based on specific design requirements, available resources, or technological advancements. In some cases, certain steps may be reordered, combined, expanded, or even omitted.

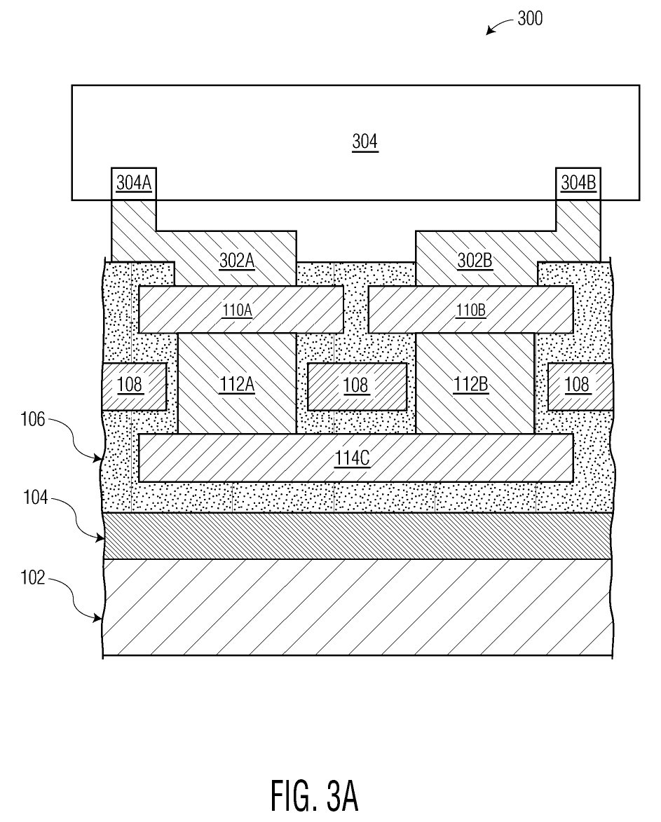

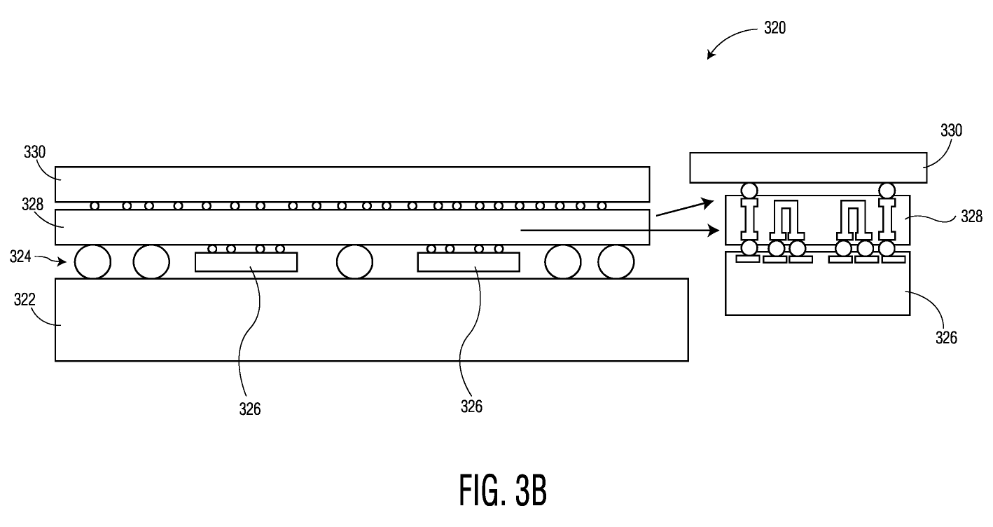

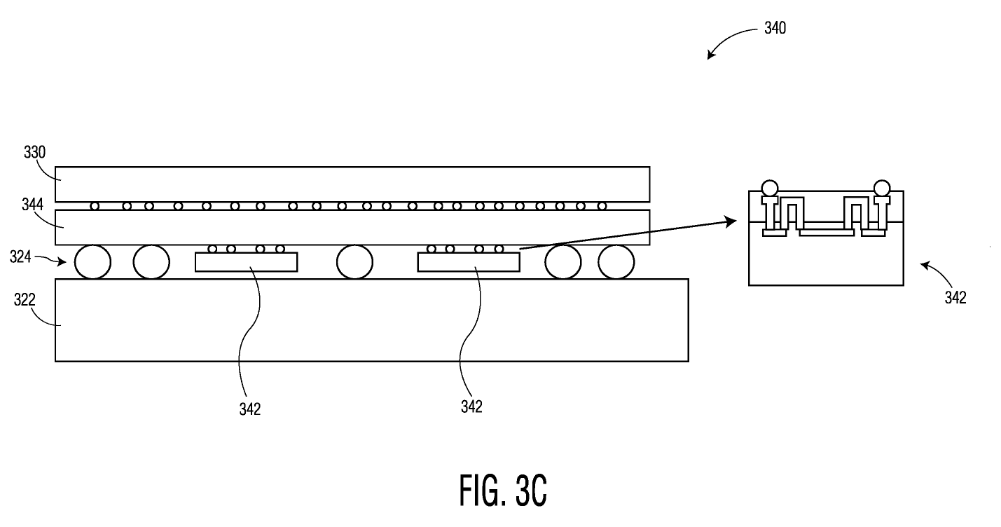

FIG. 3A illustrates a cross-sectional view of a system 300 showing the vertical integration of inductor components with an electronic device 304. FIG. 3A illustrates a system 300 including a substrate 102, a dielectric layer 104, an insulation layer 106, magnetic core segments 108, top electrodes 110A and 110B, vertical interconnects 112A and 112B, a bottom electrode 114C, electrical traces 302A and 302B, an electronic device 304, and connection pads 304A and 304B.

The inductor may incorporate similar components as the device 101 illustrated in FIG. 1B. These components may include a substrate 102, a dielectric layer 104, an insulation layer 106, magnetic core segments 108, top electrodes 110A and 110B, vertical interconnects 112A and 112B, and a bottom electrode 114C. The arrangement of these components in the system 300 may be similar to that of device 101, with the vertical inductor structure utilizing the vertical dimension to create an efficient inductive element. However, in the system 300, this vertical inductor structure may be integrated with an additional electronic device 304 positioned above it, demonstrating how the vertical inductor design may be incorporated into a larger system while maintaining its space-efficient characteristics.

Specifically, the electronic device 304 may be positioned at the top of the structure and may include a connection pad 304A and a connection pad 304B. These connection pads may interface with an electrical trace 302A and an electrical trace 302B respectively, which may provide electrical connectivity between the electronic device 304 and the inductor structure below.

The arrangement may demonstrate a vertical integration approach where the inductor components may be stacked beneath the electronic device 304, utilizing vertical space efficiently. The magnetic core 108 sections may be positioned strategically around the vertical interconnect 112A and the vertical interconnect 112B to form the inductor structure.

In some cases, the electronic device 304 may be coupled to the separate electrical connections via the electrical trace 302A and the electrical trace 302B on the substrate 102 between the electronic device 304 and the vertical inductor structure. This arrangement may facilitate electrical connections to the electronic device 304 on the first side of the magnetic core 108 using the vertical interconnect 112A and the vertical interconnect 112B.

In some implementations, the electrical trace 302A and the electrical trace 302B may be designed to align directly with the connection pad 304A and the connection pad 304B of the electronic device 304, respectively. This direct alignment may allow for a more straightforward and compact connection between the vertical inductor structure and the electronic device 304. However, in other designs, the electrical traces 302A and 302B may require routing across the substrate 102 to connect with the connection pads 304A and 304B. This routing may be desired to accommodate various layout constraints, optimize signal integrity, or facilitate connections to multiple components. The flexibility in trace routing may allow designers to adapt the vertical inductor integration to different electronic device configurations and system requirements, potentially enabling more versatile and efficient overall designs.

The vertical integration of the inductor components with the electronic device 304 may offer several benefits. In some cases, this arrangement may allow for more efficient use of chip real estate, potentially enabling higher component density and improved overall system performance. The compact nature of the vertical inductor structure may reduce the overall footprint of the system 300, which may be particularly advantageous in space-constrained applications.

Furthermore, the close proximity of the inductor components to the electronic device 304 may potentially reduce parasitic losses and improve electrical performance. In some cases, the shorter electrical paths between the inductor and the electronic device 304 may lead to reduced resistance and inductance in the interconnections, potentially resulting in more efficient power delivery or signal transmission.

The vertical integration approach may also offer flexibility in terms of system design. In some cases, the inductor components may be customized or optimized for specific electronic devices, potentially allowing for tailored performance characteristics. This may be particularly beneficial in applications such as power management systems, where the inductor characteristics may significantly impact overall system efficiency.

The vertical inductor structures described previously may be integrated into larger electronic systems to provide efficient power management and improved overall performance. FIG. 3B illustrates a cross-sectional view of a system 320 showing the vertical integration of components. The system 320 in FIG. 3B includes a PCB 322, electrical connections 324, IVRs 326, an interposer 328, and a processor 330, arranged in a vertical stack to demonstrate the integration of vertical inductor components within a larger electronic system.

The system 320 may include a PCB 322 that may serve as the base substrate. Multiple electrical connections 324 may be positioned on the PCB 322, providing interconnectivity between components. The system 320 may include IVRs 326 positioned on the interposer 328. An interposer 328 may be positioned above the IVRs 326 and may include vertical inductors and redistribution layers (RDLs). A processor 330 may be mounted on top of the interposer 328, completing the vertical stack.

In some cases, the conductive loop structure of the vertical inductors may be integrated into the interposer 328. This integration may allow for efficient power delivery between the IVRs 326 and the processor 330. The vertical inductors within the interposer 328 may provide the desired inductance for voltage regulation while minimizing the overall footprint of the system 320.

FIG. 3C illustrates a cross-sectional view of a system 340 showing an alternative arrangement of vertically integrated components. FIG. 3C illustrates a system 340 including a PCB 322, electrical connections 324, IVRs 342, an interposer 344, and a processor 330 arranged in a vertical stack.

FIG. 3C illustrates a system 340 that shares similarities with the system 320 shown in FIG. 3B, but with differences in components. The overall vertical stack structure remains similar, with a PCB 322 serving as the base, followed by electrical connections 324, and a processor 330 at the top. However, the intermediate layers in FIG. 3C feature some modifications.

In FIG. 3C, the interposer 344 differs from the interposer 328 in FIG. 3B. The interposer 344 may include RDLs but may not incorporate the vertical inductors. Instead, the vertical inductors may be integrated directly into the IVRs 342. This arrangement may represent a more tightly integrated approach, where the inductive components are incorporated directly into the voltage regulation stage rather than being housed in a separate interposer layer.

The integration of vertical inductors into larger systems, as demonstrated in FIG. 3B and FIG. 3C, may offer several advantages. In some cases, the compact nature of vertical inductors may allow for more efficient use of space within the overall system. This may be particularly beneficial in applications where size constraints are beneficial, such as in mobile devices or compact computing systems.

Furthermore, the close proximity of the vertical inductors to the components they support, such as the processor 330, may lead to improved power delivery efficiency. In some cases, the shorter electrical paths between the inductors and the processor 330 may result in reduced resistance and inductance in the power delivery network, potentially leading to better voltage regulation and reduced power losses.

The flexibility in placement of vertical inductors, either within the interposer 328, 344 or integrated into the processor 330, may allow system designers to optimize the overall system architecture for specific performance requirements. In some cases, this flexibility may enable tailored solutions for different applications, balancing factors such as power efficiency, thermal management, and electromagnetic interference.

While FIG. 3B and FIG. 3C illustrate specific configurations of systems incorporating vertical inductors, variations to these arrangements may be possible. In some cases, the number and placement of vertical inductors may be adjusted based on the specific power requirements of the system. The geometry and characteristics of the vertical inductors may also be customized to meet particular system specifications.

Additionally, the integration of vertical inductors may extend beyond the examples shown. In some cases, vertical inductors may be incorporated into other system components, such as memory modules or GPUs, to provide localized power management solutions. The principles of vertical integration demonstrated in these figures may be applied to a wide range of electronic systems, potentially enabling more compact, efficient, and high-performance designs across various applications.

The installation process for vertical inductor devices may be a step in ensuring proper integration and functionality within target systems.

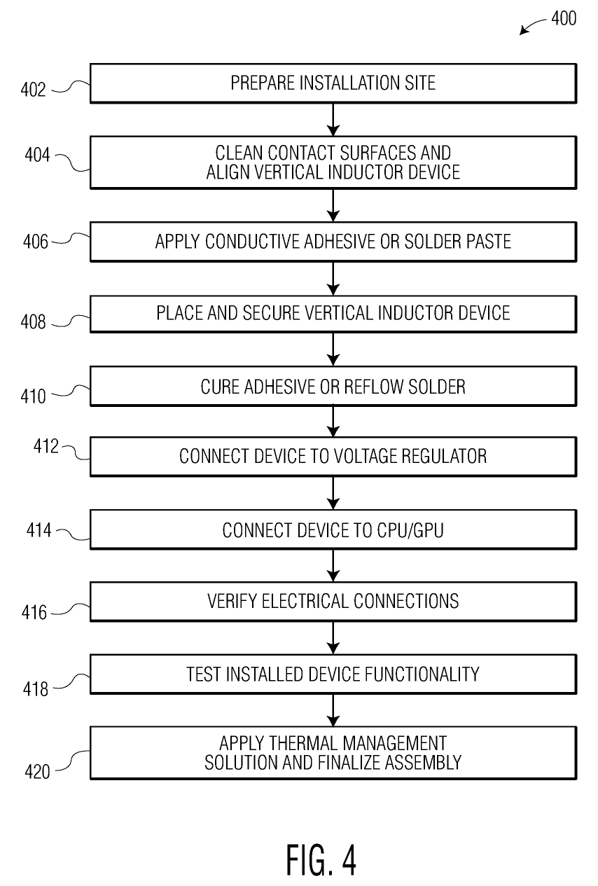

FIG. 4 illustrates a method 400 for installing a vertical inductor device. The method 400 for installing a vertical inductor device includes steps 402 (preparing the installation site), 404 (cleaning contact surfaces and aligning the device), 406 (applying conductive adhesive or solder paste), 408 (placing and securing the device), 410 (curing adhesive or performing solder reflow), 412 (connecting to voltage regulator), 414 (connecting to CPU/GPU), 416 (verifying electrical connections), 418 (testing installed device functionality), and 420 (applying thermal management solution and finalizing assembly).

The method 400 may begin with a step 402, which may involve preparing the installation site. In some cases, this preparation may include cleaning the surface where the vertical inductor device will be placed, ensuring proper grounding, and verifying that the surrounding environment meets the desired specifications for device performance.

A step 404 may involve cleaning the contact surfaces and aligning the vertical inductor device. The cleaning process may be beneficial for ensuring good electrical contact and adhesion. Alignment may be beneficial for proper integration with other components in the system, such as the electronic device 304 or the processor 330.

In a step 406, conductive adhesive or solder paste may be applied. This material may provide both mechanical attachment and electrical connectivity between the vertical inductor device and the substrate or PCB 322. The choice between conductive adhesive and solder paste may depend on factors such as the specific application, thermal requirements, and manufacturing process compatibility.

A step 408 may involve placing and securing the vertical inductor device. In some cases, this step may require precision placement equipment to ensure accurate positioning relative to other components. The securing process may involve applying pressure or temporary fixturing to hold the device in place during subsequent steps.

Step 410 may involve curing the adhesive or performing solder reflow. The specific process may depend on the attachment method chosen in step 406. Curing or reflow may be carefully controlled to ensure proper bonding without damaging the vertical inductor device or surrounding components.

A step 412 may involve connecting the vertical inductor device to a voltage regulator. This connection may be beneficial for integrating the inductor into the power delivery network of the system. In some cases, the voltage regulators 326 or the voltage regulators 342 may be connected to the vertical inductor device through the electrical connections 324 or the interposer 328.

Following the voltage regulator connection, a step 414 may involve connecting the vertical inductor device to a CPU/GPU. This step may establish the final link in the power delivery chain, allowing the vertical inductor to support the high-performance requirements of processors or graphics units. The connection may be made through components such as the interposer 328 or directly to the processor 330.

A step 416 may involve verifying the electrical connections. This verification process may include continuity tests, resistance measurements, and potentially low-power functional tests to ensure all connections are properly established and capable of carrying the current.

The method 400 may proceed to a step 418, which may involve testing the installed device functionality. This step may include more comprehensive performance tests, such as inductance measurements, quality factor assessments, and power delivery efficiency evaluations under various load conditions.

Step 420 may involve applying a thermal management solution and finalizing the assembly. Thermal management may be beneficial for maintaining performance and reliability of the vertical inductor device, especially in high-power applications. Finalization may include applying any protective coatings, attaching heat sinks, or integrating the assembly into a larger system enclosure.

It is noted that the steps illustrated in FIG. 4 are examples, and may be modified or adapted based on specific design requirements, available resources, or technological advancements. In some cases, certain steps may be reordered, combined, expanded, or even omitted.

The installation process described in method 400 may be adaptable to various vertical inductor configurations, such as the device 100, the device 101, or the multi-phase vertical inductor 120. In some cases, the specific steps may be adjusted based on the particular design of the vertical inductor and the requirements of the target system.

In some cases, when installing vertical inductors integrated into an interposer 328 or directly into voltage regulators 342, the process may involve specialized handling and testing procedures. For vertical inductors integrated into an interposer 328, care may be taken to ensure proper alignment and electrical connectivity between the inductor structures and other components in the interposer. When integrating vertical inductors directly into voltage regulators 342, the installation process may require precise positioning and connection of the inductor components within the voltage regulator package. In both cases, the installation may involve steps to verify electrical connections, test functionality, and apply appropriate thermal management solutions to optimize performance of the integrated vertical inductor structures.

The installation method 400 may be designed to ensure that the vertical inductor device is properly integrated into the target system, maximizing its performance benefits such as space efficiency, high inductance density, and improved power delivery. By following this structured approach, manufacturers may achieve consistent and reliable installation of vertical inductors across a wide range of applications, from mobile devices to high-performance computing systems.

The performance characteristics and simulation results of the vertical inductor designs may be analyzed using various methods to demonstrate their effectiveness. In these simulations, the magnetic core has perpendicular anisotropy with an easy axis perpendicular to a plane of the magnetic core. Perpendicular anisotropy refers to a magnetic property where the preferred direction of magnetization is perpendicular to the plane of the material. In the context of the magnetic core in a vertical inductor, this means the magnetic moments tend to align vertically rather than horizontally. This orientation may enhance the inductor's performance by potentially increasing its inductance and quality factor, especially at high frequencies. The perpendicular easy axis may allow for more efficient use of the vertical space in the inductor design.

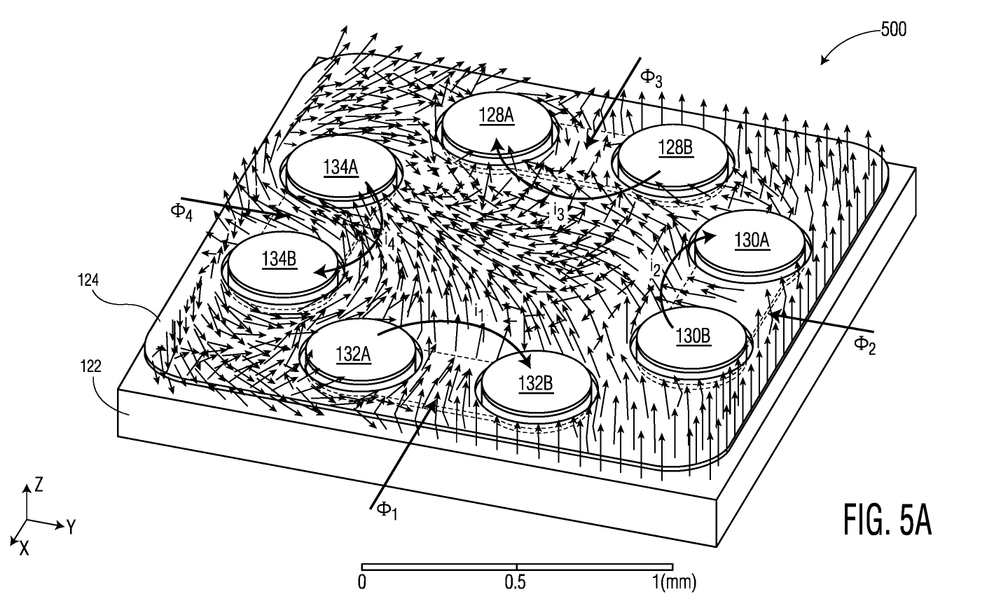

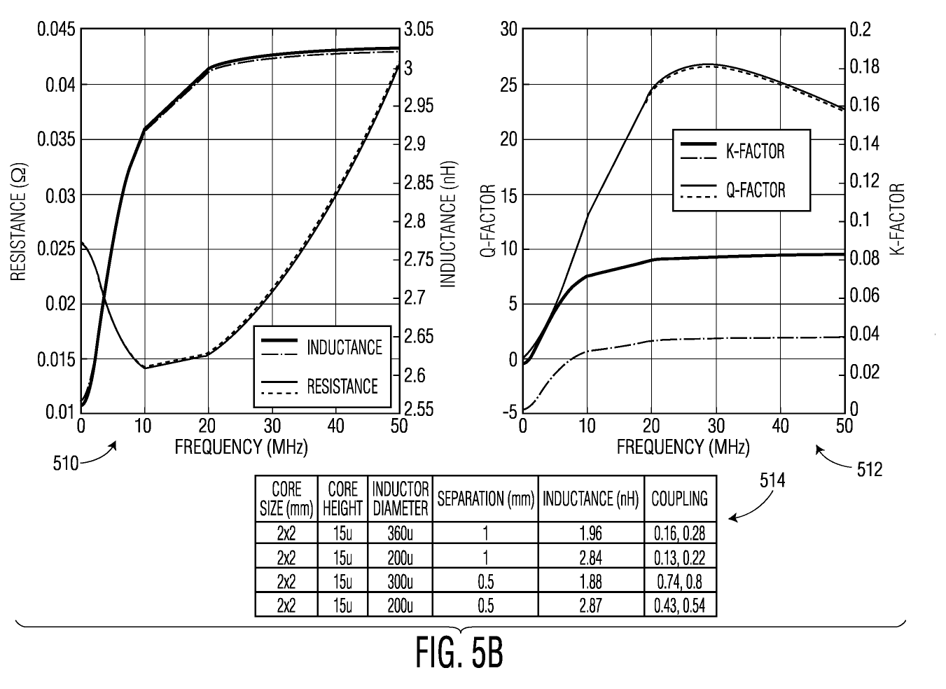

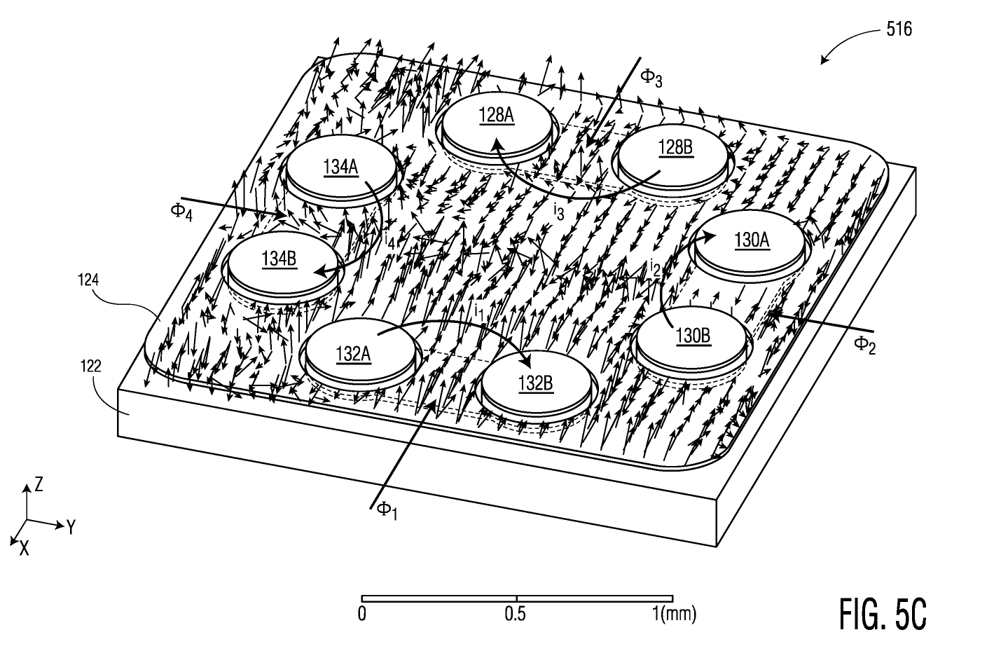

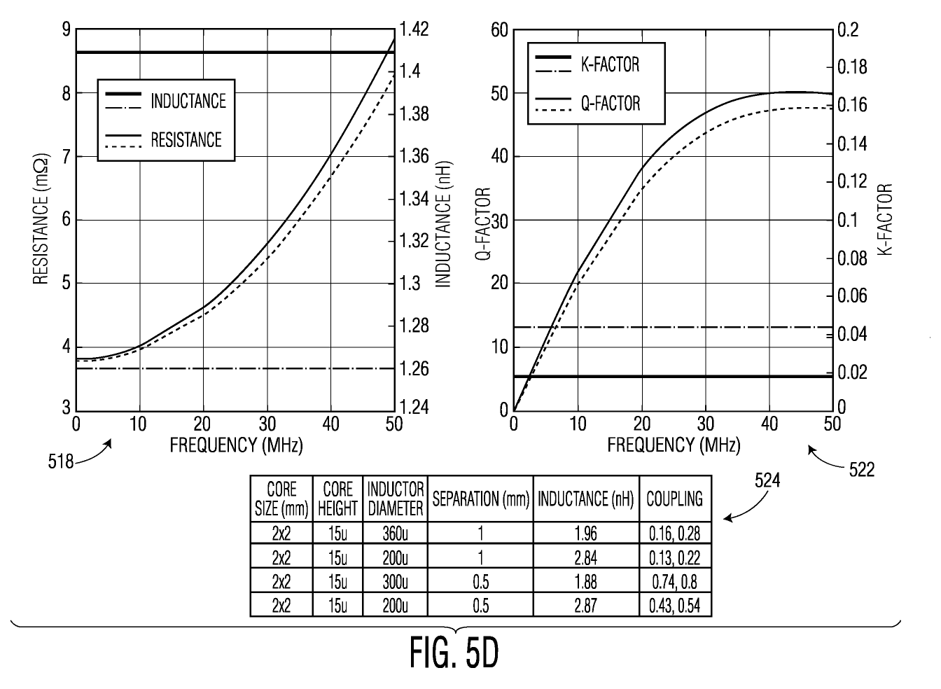

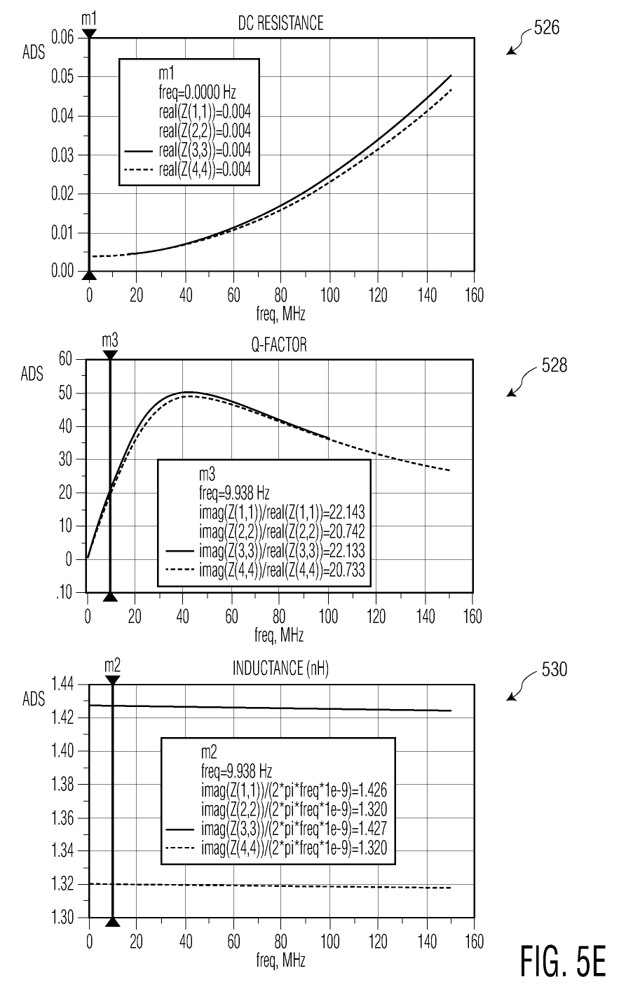

It is noted that the simulations and performance characteristics presented in FIGS. 5A-5E represent specific examples of vertical inductor designs and their associated electromagnetic behavior and electrical properties. However, it is important to note that these simulations and values are not intended to limit the scope of the invention. The actual performance, magnetic field distributions, inductance values, quality factors, and other parameters may vary depending on the specific design choices, materials used, fabrication processes, and intended applications of the vertical inductors. In some cases, the dimensions, core materials, electrode configurations, and other design aspects may be adjusted to achieve different performance characteristics tailored to particular system requirements. The simulations and data presented serve to illustrate potential capabilities and characteristics of vertical inductor designs, but the invention encompasses a broader range of possible configurations and performance outcomes.

FIG. 5A illustrates a perspective view of a magnetic field simulation 500 for coupled (e.g. a multi-phase) vertical inductor structure. The structure may include the substrate 122 supporting the magnetic core 124. Eight top electrodes (128A, 128B, 130A, 130B, 132A, 132B, 134A, and 134B) may be arranged in pairs on the magnetic core 124.

In FIG. 5A, magnetic field simulation vectors may be represented by arrows distributed across the surface, showing the magnetic field intensity and direction throughout the structure. The magnetic field simulation vectors may form circular patterns around the electrodes, potentially indicating electromagnetic coupling between adjacent electrodes. A color scale may be included to indicate the magnetic field strength (H Field) in A/m, ranging from 0 to 90 A/m.

FIG. 5B may present performance characteristics and specifications of a vertical inductor design. A resistance inductance graph 510 may show the relationship between frequency, DC resistance, and inductance. A quality factor - k factor graph 512 may display the Q-factor and k-factor variations across frequency. An inductor parameter table 514 may present detailed specifications including core dimensions, inductor parameters, and coupling factors for different configurations of the vertical inductor design.

FIG. 5C may illustrate another perspective view of a magnetic field simulation 516 for a multi-phase vertical inductor structure. The structure may include the substrate 122 with the magnetic core 124 positioned above it. The simulation may show the magnetic field distribution represented by magnetic field simulation vectors across the device. The magnetic field simulation vectors may be shown as arrows distributed across the surface, potentially indicating the direction and intensity of the magnetic field. A color scale may indicate the magnetic field strength (H Field) ranging from 0 to 390 A/m.

In FIG. 5D, a resistance inductance graph 518 may show the relationship between frequency and both resistance and inductance measurements. A quality factor - k factor graph 522 may display the Q-factor behavior across frequencies. An inductor parameter table 524 may present detailed specifications including core dimensions, heights, diameters, separation distances, inductance values, and coupling factors for different inductor configurations.

FIG. 5E may depict three performance graphs showing electrical characteristics of a vertical inductor design. A DC resistance graph 526 may show resistance increasing with frequency from 0 to 160 MHz. A quality factor graph 528 may display a peak Q-factor around 50-60 MHz before gradually decreasing. An inductance graph 530 may demonstrate stable inductance values across the frequency range, maintaining approximately 1.4 nH.

The magnetic field simulations in FIG. 5A and FIG. 5C may provide insights into the electromagnetic behavior of the vertical inductor structures. In some cases, the circular patterns formed by the magnetic field simulation vectors around the electrodes may indicate effective magnetic coupling between adjacent phases in multi-phase designs. The color scales in these simulations may allow for quantitative analysis of field strengths at different points in the structure.

The resistance inductance graphs (510 and 518) and quality factor - k factor graphs (512 and 522) may offer valuable information about the electrical performance of the vertical inductors across a range of frequencies. In some cases, these graphs may be used to identify operating frequencies or to compare the performance of different vertical inductor configurations.

The inductor parameter tables (514 and 524) may provide detailed specifications that may be beneficial for design optimization and manufacturing. In some cases, these tables may allow for comparison between different vertical inductor designs or configurations, helping to identify the most suitable options for specific applications.

The performance graphs in FIG. 5E may offer insights into the behavior of vertical inductors under varying conditions. The DC resistance graph 526 may show how resistance changes with frequency, which may be beneficial for power loss calculations. The quality factor graph 528 may indicate the efficiency of the inductor, with higher Q-factors generally indicating better performance. The inductance graph 530 may demonstrate the stability of the inductor's core characteristic across a range of frequencies.

In some cases, the simulation results and performance characteristics presented in these figures may be used to validate the effectiveness of vertical inductor designs. The data may demonstrate advantages such as high inductance density, good quality factors, and stable performance across a range of frequencies. These characteristics may make vertical inductors suitable for various applications, particularly in power management and high-frequency circuits.

The performance data may also highlight potential areas for optimization. For example, designers may use the magnetic field simulations to refine the electrode placement for improved coupling or adjust core dimensions based on the inductor parameter tables to achieve specific inductance targets.

While the figures present specific examples of vertical inductor performance, variations in design may lead to different results. In some cases, factors such as core material selection, electrode geometry, or fabrication processes may be adjusted to tailor the inductor performance for specific applications. The simulation and characterization methods demonstrated in these figures may be applied to a wide range of vertical inductor designs, potentially enabling continuous improvement and optimization of these components for various electronic systems.

The vertical inductor designs described in the preceding sections may be adapted and modified in various ways to suit different applications, manufacturing processes, and performance requirements. These variations and alternatives may demonstrate the flexibility and scalability of the vertical inductor technology.

In some cases, the magnetic core of the vertical inductor may be fabricated using advanced materials to enhance performance characteristics. For example, materials such as ECA Magcore or CZT Magcore may be employed as the magnetic core material. These advanced materials may offer improved magnetic properties, potentially leading to higher inductance values, better quality factors, or enhanced frequency response compared to more traditional core materials.

The geometry of the vertical inductor may be modified to optimize performance for specific applications. In some cases, the cross-sectional shape of the magnetic core may be altered from a simple rectangular form to more complex shapes such as T-shaped, I-shaped, tapered shapes or custom polygonal configurations. These geometric variations may allow for fine-tuning of the magnetic flux distribution and potentially improve the overall inductance density of the device.

The vertical inductor technology may be scaled to accommodate different power requirements. In some cases, larger vertical inductors may be designed for high-power applications such as electric vehicle power systems or industrial motor drives. Conversely, miniaturized versions of the vertical inductor may be developed for ultra-low-power applications in wearable devices or implantable medical systems.

The fabrication process for vertical inductors may be adapted to different manufacturing technologies. In some cases, the vertical inductor structures may be integrated into advanced packaging solutions such as fan-out wafer-level packaging or 3D integrated circuits. These integration approaches may allow for even greater miniaturization and improved electrical performance by reducing interconnect lengths.

The vertical inductor design may be combined with other passive components to create integrated passive devices. In some cases, vertical capacitors or resistors may be fabricated alongside the vertical inductors, potentially enabling the creation of compact, high-performance LC or RLC circuits within a single integrated structure.

The magnetic properties of the core may be engineered to suit specific applications. In some cases, the magnetic anisotropy of the core material may be tailored to optimize performance in different frequency ranges. Alternatively, composite magnetic materials may be developed that combine the advantageous properties of multiple magnetic substances.

The vertical inductor technology may be adapted for use in emerging applications such as quantum computing or terahertz communications. In these cases, the design may be optimized for operation at extremely high frequencies or under environmental conditions such as cryogenic temperatures.

While the described vertical inductor designs may focus on power management applications, the technology may be extended to other areas such as RF circuits or sensor systems. In some cases, the vertical inductor structures may be modified to create high-Q resonators for oscillator circuits or sensitive magnetic field sensors.

The manufacturing process for vertical inductors may be adapted to incorporate novel fabrication techniques. For example, additive manufacturing methods such as 3D printing of magnetic materials may be explored for creating custom magnetic core structures. Alternatively, advanced thin-film deposition techniques may be employed to create ultra-thin, high-performance magnetic layers.

In summary, the vertical inductor technology may offer a flexible and scalable platform for creating high-performance inductive components in a wide range of electronic systems. By leveraging advanced materials, innovative geometries, and adaptable manufacturing processes, vertical inductors may be tailored to meet the evolving needs of diverse applications across the electronics industry.

The vertical inductor technology represents a significant advancement in the field of integrated circuit design, offering a novel approach to creating high-performance inductors within semiconductor chips. By utilizing the vertical dimension of chip architecture, this innovation addresses challenges in power management and high-frequency applications, potentially enabling more compact, efficient, and high-performance electronic systems.

One of the primary benefits of vertical inductors may be their space efficiency. By leveraging the third dimension of chip design, vertical inductors may achieve high inductance values while minimizing their footprint on the chip surface. This characteristic may be particularly advantageous in applications where board space is at a premium, such as mobile devices or compact computing systems.

In addition to space efficiency, vertical inductors may offer improved performance characteristics compared to traditional planar inductors. The vertical architecture may allow for reduced parasitic capacitance and resistance, potentially enabling better performance in high-frequency applications. This may be especially beneficial in power management systems, where efficient operation at high frequencies is increasingly beneficial.

The versatility of vertical inductor technology may allow for its application across a wide range of electronic systems. In power management applications, vertical inductors may be integrated into voltage regulators and DC-DC converters, potentially improving energy efficiency and reducing overall system size. In RF circuits, the high-frequency performance of vertical inductors may enable more compact and efficient designs for communication systems.

Furthermore, the scalability of vertical inductor technology may make it suitable for various power requirements, from ultra-low-power wearable devices to high-power industrial applications. The ability to tailor the inductor characteristics through design variations in core materials, geometry, and fabrication processes may allow for optimized solutions across diverse applications.

The integration capabilities of vertical inductors may also contribute to advancements in system-on-chip (SoC) and system-in-package (SiP) designs. By incorporating high-performance inductors directly within the chip or package, vertical inductor technology may enable more comprehensive power management solutions and potentially reduce the need for external components.

According to any one of the above example embodiments, wherein forming the magnetic core comprises forming the magnetic core in a planar shape, and wherein creating the conductive loop structure comprises forming the conductive loop structure in a u-shape.

According to any one of the above example embodiments, wherein forming the magnetic core comprises dimensioning a cross section of the magnetic core relative to the conductive loop structure to achieve a target inductance value.

According to any one of the above example embodiments, the method further comprises creating multiple conductive loop structures on the magnetic core.

According to any one of the above example embodiments, wherein creating the multiple conductive loop structures comprises arranging the structures to interact and form a plurality of coupled inductors.

According to any one of the above example embodiments, the method further comprises facilitating electrical connections to an electronic device on the first side of the magnetic core using the vertical interconnects.

According to any one of the above example embodiments, wherein the electronic device comprises at least one of a voltage regulator, a DC-DC converter, a processor, or a graphics processing unit.

According to any one of the above example embodiments, wherein the coupled inductors are arranged such that in-plane flux from one inductor of the coupled inductors cancels in-plane flux from another inductor of the coupled inductors to reduce core saturation and electromagnetic interference.

According to any one of the above example embodiments, wherein the multiple conductive loop structures comprise four inductors arranged such that flux from a first inductor of the coupled inductors cancels flux from a third inductor of the coupled inductors and flux from a second inductor of the coupled inductors cancels flux from a fourth inductor of the coupled inductors to reduce core saturation and electromagnetic interference.

According to any one of the above example embodiments, the method further comprises coupling a voltage regulator to the vertical inductor and to an electronic device, wherein the vertical inductor is connected to the voltage regulator through vertical connections, and the voltage regulator is connected to the electronic device through vertical connections.

According to any one of the above example embodiments, wherein the magnetic core comprises a planar shape and the conductive loop structure comprises a u-shape.

According to any one of the above example embodiments, wherein the cross section of the magnetic core comprises dimensions relative to the conductive loop structure to achieve a target inductance value.

According to any one of the above example embodiments, wherein the vertical inductor further comprises multiple conductive loop structures on the magnetic core.

According to any one of the above example embodiments, wherein the multiple conductive loop structures interact to form a plurality of coupled inductors.

According to any one of the above example embodiments, wherein the separate electrical connections facilitate electrical connections to an electronic device on the first side of the magnetic core.

According to any one of the above example embodiments, wherein the electronic device comprises at least one of a voltage regulator, a DC-DC converter, a processor, or a graphics processing unit.

According to any one of the above example embodiments, wherein the magnetic core has perpendicular anisotropy with an easy axis perpendicular to a plane of the magnetic core.

According to any one of the above example embodiments, wherein the conductive loop and the magnetic core has a thickness from 8um-100um.

According to any one of the above example embodiments, wherein the coupled inductors may be arranged such that in-plane flux from one inductor of the coupled inductors cancels in-plane flux from another inductor of the coupled inductors to reduce core saturation and electromagnetic interference.

According to any one of the above example embodiments, wherein the multiple conductive loop structures may comprise four inductors arranged such that flux from a first inductor of the coupled inductors cancels flux from a third inductor of the coupled inductors and flux from a second inductor of the coupled inductors cancels flux from a fourth inductor of the coupled inductors to reduce core saturation and electromagnetic interference.

According to any one of the above example embodiments, wherein the vertical inductor further comprises a voltage regulator coupled to the vertical inductor and to an electronic device, wherein the vertical inductor is connected to the voltage regulator through vertical connections, and the voltage regulator is connected to the electronic device through vertical connections.

According to any one of the above example embodiments, wherein the magnetic core comprises a planar shape and the conductive loop structure comprises a u-shape.

According to any one of the above example embodiments, wherein the cross section of the magnetic core comprises dimensions relative to the conductive loop structure to achieve a target inductance value.

According to any one of the above example embodiments, wherein the vertical inductor further comprises multiple conductive loop structures on the magnetic core, wherein the multiple conductive loop structures interact to form a plurality of coupled inductors.

According to any one of the above example embodiments, wherein the electronic device coupled to the separate electrical connections via electrical traces on the substrate between the electronic device and the vertical inductor.

According to any one of the above example embodiments, wherein the electronic device comprises at least one of a voltage regulator, a DC-DC converter, a processor, or a graphics processing unit.

According to any one of the above example embodiments, wherein the conductive loop structure is integrated into an interposer between the electronic device and an additional electronic device electrically connected to each other.

According to any one of the above example embodiments, wherein the conductive loop structure is integrated into the electronic device.

According to any one of the above example embodiments, wherein the coupled inductors are arranged such that in-plane flux from one inductor of the coupled inductors cancels in-plane flux from another inductor of the coupled inductors to reduce core saturation and electromagnetic interference.

According to any one of the above example embodiments, wherein the multiple conductive loop structures comprise four inductors arranged such that flux from a first inductor of the coupled inductors cancels flux from a third inductor of the coupled inductors and flux from a second inductor of the coupled inductors cancels flux from a fourth inductor of the coupled inductors to reduce core saturation and electromagnetic interference.

According to any one of the above example embodiments, the system further comprises a voltage regulator coupled to the vertical inductor and to the electronic device, wherein the vertical inductor is connected to the voltage regulator through vertical connections, and the voltage regulator is connected to the electronic device through vertical connections.

While the foregoing is directed to example embodiments described herein, other and further example embodiments may be devised without departing from the basic scope thereof. For example, aspects of the present disclosure may be implemented in hardware or software or a combination of hardware and software. Portions of the disclosure described herein may be implemented as a program product for use with a computer system. The program(s) of the program product defines functions of the example embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid-state random-access memory) on which alterable information is stored. Such computer-readable storage media, when carrying computer-readable instructions that direct the functions of the presented example embodiments, are example embodiments of the present disclosure.

It will be appreciated by those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is claimed is:

1. A method of manufacturing a vertical inductor, the method comprising:
forming a substrate;
forming a bottom electrode;
forming a dielectric layer;
forming a magnetic core;
forming insulation layer; and
forming a conductive loop structure by:
extending vertical interconnects through the insulation layer from a first side of the magnetic core to a second side of the magnetic core, and
electrically connecting the vertical interconnects to the bottom electrode on the second side of the magnetic core.

2. The method of claim 1, wherein forming the magnetic core comprises forming the magnetic core in a planar shape, and wherein creating the conductive loop structure comprises forming the conductive loop structure in a u-shape.

3. The method of claim 1, wherein forming the magnetic core comprises dimensioning a cross section of the magnetic core relative to the conductive loop structure to achieve a target inductance value.

4. The method of claim 1, further comprising creating multiple conductive loop structures on the magnetic core.

5. The method of claim 4, wherein creating the multiple conductive loop structures comprises arranging the structures to interact and form a plurality of coupled inductors.

6. The method of claim 5, wherein the coupled inductors are arranged such that in-plane flux from one inductor of the coupled inductors cancels in-plane flux from another inductor of the coupled inductors to reduce core saturation and electromagnetic interference.

7. The method of claim 5, wherein the multiple conductive loop structures comprise four inductors arranged such that flux from a first inductor of the coupled inductors cancels flux from a third inductor of the coupled inductors and flux from a second inductor of the coupled inductors cancels flux from a fourth inductor of the coupled inductors to reduce core saturation and electromagnetic interference.

8. A vertical inductor comprising:
a magnetic core disposed on a substrate, the magnetic core comprising insulated vias extending through a cross section of the magnetic core; and
a conductive loop structure comprising vertical interconnects extending through the insulated vias from a first side of the magnetic core to a second side of the magnetic core, the vertical interconnects electrically connected to each other on the second side of the magnetic core by a horizontal conductive layer, the vertical interconnects comprising separate electrical connections on the first side of the magnetic core.

9. The vertical inductor of claim 8, wherein the magnetic core comprises a planar shape and the conductive loop structure comprises a u-shape.

10. The vertical inductor of claim 8, wherein the cross section of the magnetic core comprises dimensions relative to the conductive loop structure to achieve a target inductance value.

11. The vertical inductor of claim 8, further comprising multiple conductive loop structures on the magnetic core.

12. The vertical inductor of claim 11, wherein the multiple conductive loop structures interact to form a plurality of coupled inductors.

13. The vertical inductor of claim 12, wherein the multiple conductive loop structures may comprise four inductors arranged such that flux from a first inductor of the coupled inductors cancels flux from a third inductor of the coupled inductors and flux from a second inductor of the coupled inductors cancels flux from a fourth inductor of the coupled inductors to reduce core saturation and electromagnetic interference.

14. The vertical inductor of claim 12, further comprising a voltage regulator coupled to the vertical inductor and to an electronic device, wherein the vertical inductor is connected to the voltage regulator through vertical connections, and the voltage regulator is connected to the electronic device through vertical connections.

15. A system comprising:
an electronic device; and
a vertical inductor coupled to the electronic device, the vertical inductor comprising:
a magnetic core disposed on a substrate, the magnetic core comprising insulated vias extending through a cross section of the magnetic core, and
a conductive loop structure comprising vertical interconnects extending through the insulated vias from a first side of the magnetic core to a second side of the magnetic core, the vertical interconnects electrically connected to each other on the second side of the magnetic core by a horizontal conductive layer, the vertical interconnects comprising separate electrical connections on the first side of the magnetic core, the electronic device coupled to the separate electrical connections.

16. The system of claim 15, wherein the magnetic core comprises a planar shape and the conductive loop structure comprises a u-shape.

17. The system of claim 15, wherein the cross section of the magnetic core comprises dimensions relative to the conductive loop structure to achieve a target inductance value.

18. The system of claim 15, wherein the vertical inductor further comprises multiple conductive loop structures on the magnetic core, wherein the multiple conductive loop structures interact to form a plurality of coupled inductors.

19. The system of claim 18, wherein the electronic device coupled to the separate electrical connections via electrical traces on the substrate between the electronic device and the vertical inductor.

20. The system of claim 15, wherein the electronic device comprises at least one of a voltage regulator, a DC-DC converter, a processor, or a graphics processing unit.
